(19) United States
(12) Patent Application Publication
(10) Pub. No.: US 2008/0093457 A1
(43) Pub. Date: Apr. 24, 2008

(54) Imaging reader and method with visual aiming prompts

(76) Inventors: Dayou Wang, Jefferson Station, NY (US); Joseph Cai, Rocky Point, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/583,548

(22) Filed: Oct. 19, 2006

(51) Int. Cl. G06K 7/10

(52) U.S. Cl. 235/462.21

(57) ABSTRACT

An aiming assembly supported by a mobile imaging reader projects a visual prompt, preferably one or more arrows, on a symbol to indicate a direction in which a field of view of an imager in the housing is to be moved in order to position the symbol entirely within the field of view prior to electro-optically reading the symbol.

### DESCRIPTION OF THE RELATED ART

Solid-state imaging readers have been used in supermarkets, warehouse clubs, department stores, and other kinds of retailers to electro-optically read one-dimensional bar code symbols, particularly of the Universal Product Code (UPC) type, on products to be purchased, each symbol having a row of bars and spaces spaced apart along one direction, and also for processing two-dimensional symbols, such as Code 49, on such products, as well as other items. The structure of Code 49, which introduced the concept of vertically stacking a plurality of rows of bar and space patterns in a single symbol, is described in U.S. Pat. No. 4,794,239. Another two-dimensional code structure for increasing the amount of data that can be represented or stored on a given amount of surface area is known as PDF417 and is described in U.S. Pat. No. 5,304,786.

A typical imaging reader has a one- or two-dimensional array of cells or photosensors, which correspond to image elements or pixels in a field of view of the array, and is similar to that used in a digital camera. The array may be a one- or two-dimensional charge coupled device (CCD) or a complementary metal oxide semiconductor (CMOS) device, together with associated circuits for producing electronic signals corresponding to a one- or two-dimensional array of pixel information over the field of view. A microprocessor is used to analyze and decode the captured image of the symbol. The array may be used for capturing a monochrome image of a symbol as, for example, disclosed in U.S. Pat. No. 5,703,349. The array may have multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

Yet, the use of imaging readers, especially hand-held movable readers, for reading symbols has proven to be challenging. The operator cannot see exactly whether the symbol is within the field of view of the array during reading. The symbol must lie entirely within the field of view to be successfully decoded and read. It is not uncommon for the operator to repeatedly move the portable reader in multiple directions and repeatedly aim the portable reader at a single symbol several times before an indicator advises the operator that the symbol has been successfully read, thereby slowing down transaction processing and reducing productivity. This blind-aiming at the symbol is easier if the symbol is relatively small or is far away from the reader, because then the chances that the symbol will lie within the field of view are greater. However, in most cases, this blind-aiming at the symbol is difficult to overcome, especially when the position and orientation of the symbol are variable. The symbol may be oriented in a “picket fence” orientation in which the elongated parallel bars of the one-dimensional UPC symbol are vertical, or in a “ladder” orientation in which the symbol bars are horizontal, or at any orientation angle in between.

### SUMMARY OF THE INVENTION

One feature of the present invention resides, briefly stated, in a reader for, and a method of, electro-optically reading a target, especially one-dimensional symbols or two-dimensional symbols. The reader is preferably embodied as a portable, point-of-transaction, gun-shaped, hand-held housing, but could be embodied as a hand-held, box-shaped housing, or the like. Prior to reading of the symbols, the reader is brought to, and aimed at, the symbols. In the preferred embodiment, the reader is installed in a retail establishment, such as a supermarket, but can be installed virtually anywhere requiring symbols to be read.

A one- or two-dimensional, solid-state imager under control of a controller is mounted in the reader, and includes an array of image sensors operative for capturing light from a one-dimensional and/or a two-dimensional symbol over a field of view, and for generating electrical signals indicative of the captured light. The field of view of the imager diverges in an outward direction away from the imager. Preferably, the array is a charge coupled device (CCD) or a complementary metal oxide semiconductor (CMOS) array. An imaging lens is preferably mounted in the reader in front of the imager to focus the captured light onto the imager. The imaging lens causes the field of view to rapidly widen at a steeper angle of divergence.

The imager may be associated with a high-speed strobe illuminator under control of the controller to enable the image of the symbol to be acquired in a very short period of time, for example, on the order of 500 microseconds, so that the symbol image is not blurred even if there is relative motion between the imager and the symbol. The strobe illumination is preferably brighter than ambient illumination. The illumination can also be continuous. The imager captures light over an exposure time period, also under the control of the controller. A short exposure time also prevents image blurring.

The controller is also operative for processing the electrical signals, and for determining how the symbol is positioned relative to the field of view. In accordance with one feature of this invention, an aiming arrangement is supported by the housing and is operatively connected to the controller, for projecting a visual prompt to indicate a direction in which the housing is to be moved in order to position the symbol entirely within the field of view prior to reading.

The aiming arrangement configures the visual prompt as at least one arrow and preferably a plurality of arrows. In the preferred embodiment, there are four mutually orthogonal arrows, one of which points in a rightward direction, another of which points in a leftward direction, still another of which points in an upward direction, and yet another of which points in a downward direction, all of said directions being respectively similar to the east, west, north and south points of a compass, as considered in a plane in which the symbol is situated.

The aiming arrangement includes at least one light projector and preferably a plurality of projectors. Each projector includes a light source, such as a laser, a focusing lens, and a diffractive optical element (DOE). Each projector is responsible for configuring and displaying a single arrow, although it is possible to display more than one arrow with a single projector.

In use, the controller initially determines how the symbol is positioned relative to the field of view of the imager. If, for example, a lower part of a symbol extends downwardly outside the field of view, then the downward arrow is displayed on the symbol to visually prompt the operator to shift the housing and, hence, the field of view downwardly. When the symbol is entirely within the shifted field of view, the symbol will be read, and an indicator will so advise the operator. The situation is analogous for those situations where a right, left or upper part of the symbol extends past the field of view. In situations where more than one part of the symbol is outside the field of view, then more than one arrow is displayed to enable the operator to move the field of view in more than one direction, for example, along a diagonal direction. In situations where the symbol is larger than the field of view, then all four arrows are displayed to enable the operator to move the field of view in a direction generally perpendicular to the plane in which the symbol is situated in order to position the symbol entirely within the field of view prior to reading.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an imaging reader for electro-optically reading symbols by image capture in accordance with this invention;

FIG. 2 is a diagrammatic plan view of components within the reader of FIG. 1 including components of an aiming arrangement;

FIG. 3 is a front elevational view of a part of the reader of FIG. 1 showing additional components of the aiming arrangement;

FIG. 4 is a diagrammatic plan view of a symbol outside the field of view of an imager during use of the reader of FIG. 1;

FIG. 5 is a diagrammatic plan view of a visual prompt produced by the aiming arrangement for the situation of FIG. 4;

FIG. 6 is a diagrammatic plan view of a symbol larger than the field of view of an imager during use of the reader of FIG. 1; and

FIG. 7 is a diagrammatic plan view of a visual prompt produced by the aiming arrangement for the situation of FIG. 6.

### DETAILED DESCRIPTION OF THE PREFERRED EMBODIMENTS

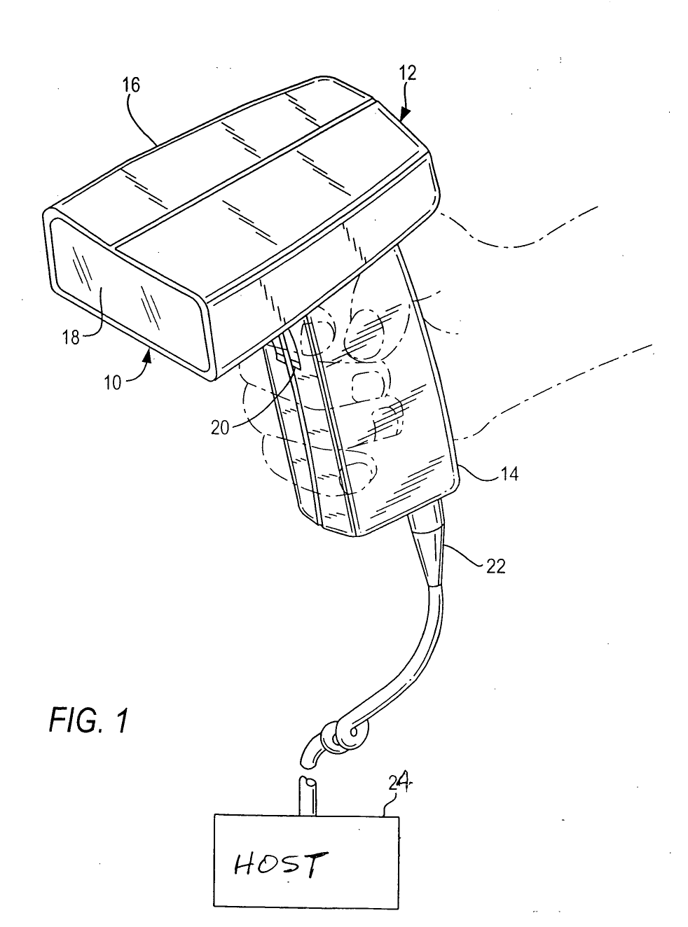

Reference numeral 10 in FIG. 1 generally identifies a hand-held imaging reader for electro-optically reading symbols or like indicia on products or like targets. The reader 10 includes a housing 12 in which an aiming arrangement, as described in detail below in accordance with this invention, is incorporated. The housing 12 includes a generally elongated handle or lower handgrip portion 14 and a barrel or upper body portion 16 having a front end at which a light-transmissive window 18 is located. The cross-sectional dimensions and overall size of the handle are such that the reader can conveniently be held in a user's hand. The body and handle portions may be constructed of a lightweight, resilient, shock-resistant, self-supporting material such as a synthetic plastic material. The plastic housing may be injection molded, but can be vacuum-formed or blow-molded to form a thin hollow shell which bounds an interior space whose volume is sufficient to contain the various components of this invention.

A manually actuatable trigger 20 is mounted in a moving relationship on the handle 14 in a forward facing region of the reader. The user's forefinger is used to actuate the reader to initiate reading by depressing the trigger. An optional flexible electrical cable 22 is provided to connect the reader to a remote host 24. The cable may also provide electrical power to the reader. The host 24 has access to a database for retrieval of information. If the cable 22 is not used, then a wireless link to transfer data may be provided between the reader 10 and the host 24, and an on-board battery, typically within the handle, can be used to supply electrical power.

An alternative embodiment incorporates a display and a keyboard. Data obtained from reading the symbols is then either transferred to the remote host 24 in real time, or saved to an internal memory such that the stored data can be transferred to the host 24 at a later time in batch mode.

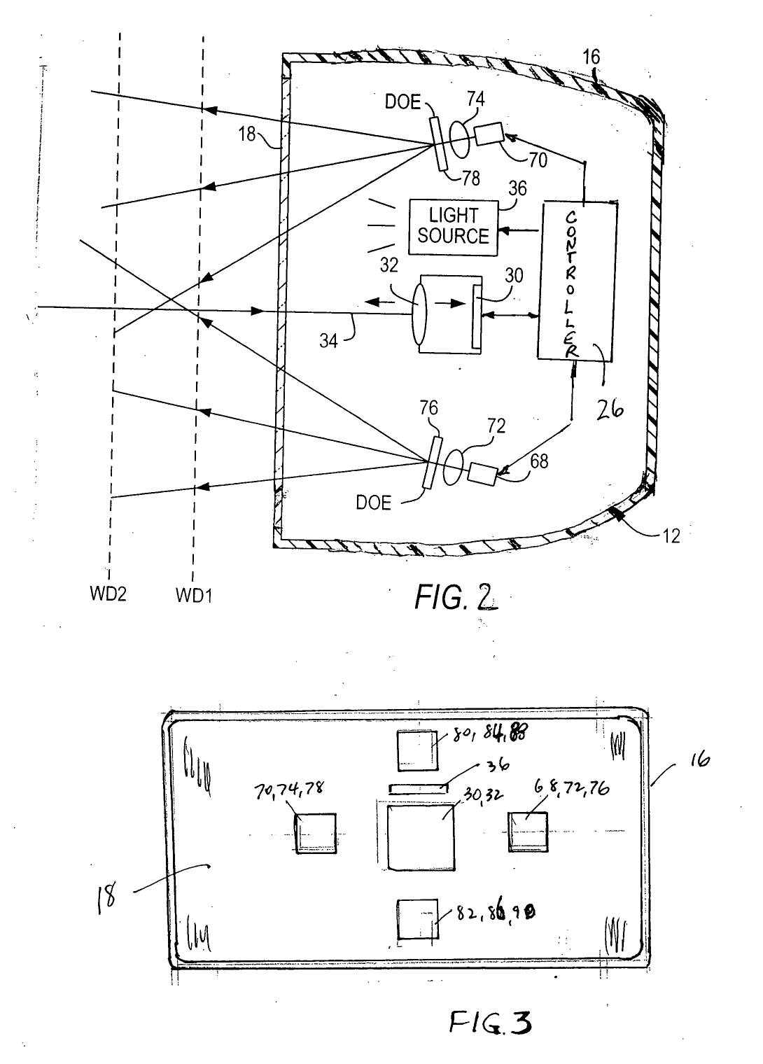

A solid-state imager 30, as shown in the interior plan view of FIG. 2, is mounted within the housing 12 and preferably is a one- or two-dimensional, charge coupled device (CCD) or complementary metal oxide semiconductor (CMOS) array of cells or sensors operative for capturing light over its field of view from a symbol through the window 18 and focused by a lens assembly 32. The sensors produce electrical signals corresponding to a one-or two-dimensional array of pixel information for an image of the symbol. The electrical signals are processed by a controller or microprocessor 26. The imager 30 and lens assembly 32 are preferably aligned along a centerline or an optical axis 34 generally centrally located within the body portion 16. As shown in FIG. 2, the lens assembly 32 has a fixed focus and enables image capture over a range of working distances between a close-in distance WD1 and a far-out distance WD2 relative to the window 18. The imager and lens assembly are capable of acquiring a full image of the symbol in lighting conditions from two lux to direct sunlight. Exposure time is about 15 milliseconds and controlled by the controller 26. Resolution of the array can be of various sizes although VGA resolution of 640×480 pixels is preferred.

An illumination source 36 for the imager 30 is also provided to provide an illumination field for the imager. The source 36 preferably constitutes a plurality of light emitting diodes energized by power supply lines in the cable 22, or via the on-board battery. The source 36 is preferably pulsed in synchronism with the imager 30 under the control of the controller 26.

As described so far, many users have difficulty using the described hand-held movable reader, because they cannot see exactly whether the symbol is within the field of view of the imager array 30 during reading. The symbol must lie entirely within the field of view to be successfully decoded and read. Many users need to repeatedly move the reader in multiple directions and repeatedly aim the reader at a single symbol several times before an indicator advises the user that the symbol has been successfully read, thereby slowing down transaction processing and reducing productivity.

In accordance with one feature of this invention, the controller 26 processes the electrical signals, and determines how the symbol is positioned relative to the field of view. Once this positional information is obtained, an aiming arrangement supported by the housing 12 and operatively connected to the controller 26, is operative for projecting a visual prompt to indicate a direction in which the housing 12 is to be moved in order to position the symbol entirely within the field of view prior to reading. Once the symbol is entirely within the field of view, it can be successfully decoded by the controller 26.

The aiming arrangement configures the visual prompt as at least one arrow and preferably a plurality of arrows 100, 102, 104, 106, as shown in FIG. 7. In the preferred embodiment, there are four mutually orthogonal arrows, one 100 of which points in a rightward direction, another 102 of which points in a leftward direction, still another 104 of which points in an upward direction, and yet another 106 of which points in a downward direction, all of said directions being respectively similar to the east, west, north and south points of a compass, as considered in a plane in which the symbol is situated.

The aiming arrangement includes a light projector for displaying each arrow on the symbol. Each projector includes a light source, such as a laser, a focusing lens, and a diffractive optical element (DOE). Thus, as shown in FIG. 2, light sources 68, 70, focusing lenses 72, 74, and DOEs 76, 78 are responsible for configuring and displaying the arrows 102, 100 on the symbol. Similarly, as shown schematically in FIG. 3, light sources 80, 82, focusing lenses 84, 86, and DOEs 88, 90 are responsible for configuring and displaying the arrows 106, 104 on the symbol. The focused light passing through a respective DOE forms multiple diverging beamlets, as described in U.S. Pat. No. 6,340,114, which exit the window 18 and project continuous lines or rows of spots arrayed in a pattern of the respective arrows 100, 102, 104, 106 on the symbol throughout the working distance range.

Diffractive optics creates a bright, crisp arrow pattern which provides ready feedback to the user regarding the direction in which the housing 12 and, hence, the field of view is to be moved in order to position the symbol entirely within the field of view, as described below. In a preferred embodiment, each laser light source has an output power of 5 milliwatts and a wavelength of 650 nanometers. Instead of diffractive optics, it is also possible to use masks to project an arrow pattern onto the symbol.

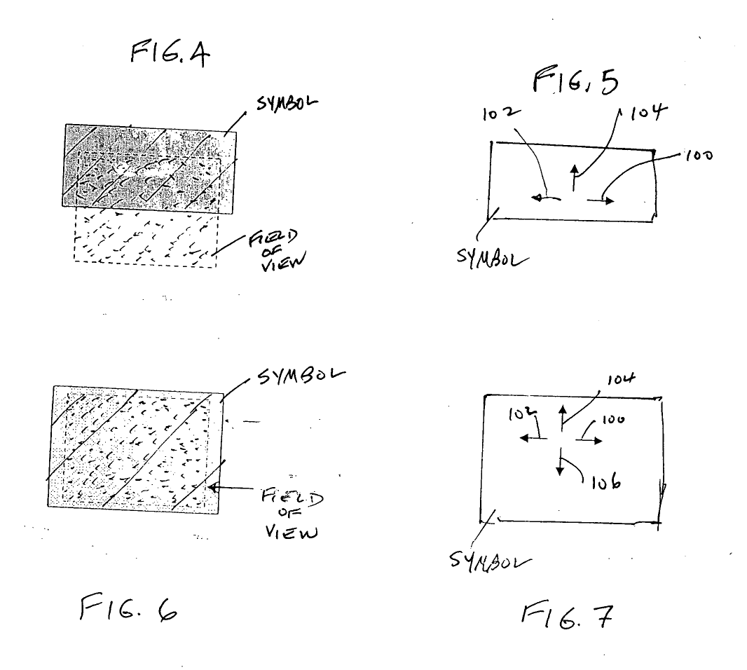

In use, the user points the reader at a symbol to be read and manually depresses the trigger 20 to initiate reading. The controller 26 activates the imager 30 and the illumination source 36 and initially determines whether a symbol, as opposed to something else, is indeed at least partially in the field of view and, if so, how the symbol is positioned relative to the field of view. If, for example, an upper part of a symbol, as shown in FIG. 4, extends upwardly beyond the field of view, then the controller 26 activates the appropriate projector or projectors to display at least the upward arrow 104 (see FIG. 5) on the symbol to visually prompt the operator to shift the housing 16 and, hence, the field of view upwardly. When the symbol is entirely within the shifted field of view, then the symbol will be read, and an indicator will so advise the operator. Preferably, each projector is deactivated during the reading of the symbol.

The situation is analogous for those situations where a right, left or upper part of the symbol extends beyond the field of view. In situations where more than one part of the symbol is outside the field of view, then more than one arrow is displayed to enable the operator to move the field of view in more than one direction, for example, along a diagonal direction.

In situations where the symbol is larger than the field of view, as for example depicted in FIG. 6, then all four arrows are displayed to enable the operator to move the field of view in opposite directions along the axis 34 in a direction generally perpendicular to the plane in which the symbol is situated in order to position the symbol entirely within the field of view prior to reading.

It will be understood that each of the elements described above, or two or more together, also may find a useful application in other types of constructions differing from the types described above. Thus, readers having different configurations can be used.

While the invention has been illustrated and described as shifting a field of view in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading symbols, comprising:
a housing movable by an operator;
a solid-state imager supported by the housing, for capturing light over a field of view from a symbol, and for generating electrical signals indicative of the captured light;
a controller supported by the housing, for processing the electrical signals, and for determining how the symbol is positioned relative to the field of view; and
an aiming assembly supported by the housing and operatively connected to the controller, for projecting a visual prompt to indicate a direction in which the housing is to be moved in order to position the symbol entirely within the field of view prior to reading.

2. The reader of claim 1, wherein the aiming assembly includes at least one light projector for configuring the visual prompt as an arrow.

3. The reader of claim 2, wherein the at least one light projector includes a light source and a diffractive optical element.

4. The reader of claim 1, wherein the aiming assembly includes a plurality of light projectors for configuring the visual prompt as a plurality of arrows.

5. The reader of claim 4, wherein each light projector includes a light source and a diffractive optical element.

6. The reader of claim 1, wherein the visual prompt is at least one arrow from a group of four mutually orthogonal arrows, one of which points in a rightward direction, another of which points in a leftward direction, still another of which points in an upward direction, and yet another of which points in a downward direction, all of said directions being considered in a plane in which the symbol is situated.

7. The reader of claim 1, wherein the visual prompt is a group of four mutually orthogonal arrows, one of which points in a rightward direction, another of which points in a leftward direction, still another of which points in an upward direction, and yet another of which points in a downward direction, all of said directions being considered in a plane in which the symbol is situated, and wherein the housing is moved in a direction generally perpendicular to the plane in order to position the symbol entirely within the field of view prior to reading.

8. The reader of claim 1, wherein the imager is one of a charge coupled device and a complementary metal oxide silicon device, and wherein the symbol is one of a one-dimensional symbol and a two-dimensional symbol.

9. A reader for electro-optically reading symbols, comprising:
housing means movable by an operator;
imaging means supported by the housing means, for capturing light over a field of view from a symbol, and for generating electrical signals indicative of the captured light;
control means supported by the housing means, for processing the electrical signals, and for determining how the symbol is positioned relative to the field of view; and
aiming means supported by the housing means and operatively connected to the control means, for projecting a visual prompt to indicate a direction in which the housing means is to be moved in order to position the symbol entirely within the field of view prior to reading.

10. An arrangement for aiming at symbols to be electro-optically read, comprising:
a movable solid-state imager for capturing light over a field of view from a symbol, and for generating electrical signals indicative of the captured light;
a controller for processing the electrical signals, and for determining how the symbol is positioned relative to the field of view; and
an aiming assembly operatively connected to the controller, for projecting a visual prompt to indicate a direction in which the imager is to be moved in order to position the symbol entirely within the field of view prior to being electro-optically read.

11. The arrangement of claim 10, wherein the aiming assembly includes at least one light projector for configuring the visual prompt as an arrow.

12. The arrangement of claim 11, wherein the at least one light projector includes a light source and a diffractive optical element.

13. The arrangement of claim 10, wherein the aiming assembly includes a plurality of light projectors for configuring the visual prompt as a plurality of arrows.

14. The arrangement of claim 13, wherein each light projector includes a light source and a diffractive optical element.

15. The arrangement of claim 10, wherein the visual prompt is at least one arrow from a group of four mutually orthogonal arrows, one of which points in a rightward direction, another of which points in a leftward direction, still another of which points in an upward direction, and yet another of which points in a downward direction, all of said directions being considered in a plane in which the symbol is situated.

16. The arrangement of claim 10, wherein the visual prompt is a group of four mutually orthogonal arrows, one of which points in a rightward direction, another of which points in a leftward direction, still another of which points in an upward direction, and yet another of which points in a downward direction, all of said directions being considered in a plane in which the symbol is situated, and wherein the imager is moved in a direction generally perpendicular to the plane in order to position the symbol entirely within the field of view prior to being electro-optically read.

17. The arrangement of claim 10, wherein the imager is one of a charge coupled device and a complementary metal oxide silicon device, and wherein the symbol is one of a one-dimensional symbol and a two-dimensional symbol.

18. A method of electro-optically reading symbols, comprising the steps of:
moving a housing by an operator;
capturing light over a field of view from a symbol, and generating electrical signals indicative of the captured light;
processing the electrical signals, and determining how the symbol is positioned relative to the field of view; and
projecting a visual prompt to indicate a direction in which the housing is to be moved in order to position the symbol entirely within the field of view prior to reading.

19. The method of claim 18, and configuring the visual prompt as an arrow.

20. The method of claim 19, wherein the configuring step is performed by a light source and a diffractive optical element.

21. The method of claim 18, and configuring the visual prompt as a plurality of arrows.

22. The method of claim 18, and configuring the visual prompt as at least one arrow from a group of four mutually orthogonal arrows, one of which points in a rightward direction, another of which points in a leftward direction, still another of which points in an upward direction, and yet another of which points in a downward direction, all of said directions being considered in a plane in which the symbol is situated.

23. The method of claim 18, and configuring the visual prompt as a group of four mutually orthogonal arrows, one of which points in a rightward direction, another of which points in a leftward direction, still another of which points in an upward direction, and yet another of which points in a downward direction, all of said directions being considered in a plane in which the symbol is situated, and wherein the step of moving the housing is performed in a direction generally perpendicular to the plane in order to position the symbol entirely within the field of view prior to reading.
